(19) United States
(12) Patent Application Publication
(10) Pub. No.: US 2022/0172161 A1
(43) Pub. Date: Jun. 2, 2022

(54) TECHNOLOGIES FOR AUTONOMOUS TRANSFER OF PRODUCTS IN A TRADE AREA FOR HOME DELIVERY

(71) Applicants: John Miller, Santa Monica, CA (US); Harry Tsao, Santa Monica, CA (US); Michael Montagano, Santa Monica, CA (US)

(72) Inventors: John Miller, Santa Monica, CA (US); Harry Tsao, Santa Monica, CA (US); Michael Montagano, Santa Monica, CA (US)

(21) Appl. No.: 17/539,016

(22) Filed: Nov. 30, 2021

Related U.S. Application Data
(60) Provisional application No. 63/119,394, filed on Nov. 30, 2020.

(51) Int. Cl. G06Q 10/08; G06V 20/62; G06V 40/16; G05D 1/10; B64D 1/02; B64D 1/22; B64C 39/02

(52) U.S. Cl. CPC G06Q 10/0832; G06Q 10/08355; G06Q 10/087; G06V 20/625; B64C 2201/128; G05D 1/101; B64D 1/02; B64D 1/22; B64C 39/024; G06V 40/172

(57) ABSTRACT

Technologies for intelligent transfer of products include an autonomous transfer vehicle to receive a retail product, navigate to a predetermined location, and unload the retail product. The retail product may include grocery products or fresh food. The predetermined location may be associated with a delivery vehicle. The predetermined location may be a hyperlocal aggregation facility. The autonomous transfer vehicle may be a shopping cart with a vision system and an electric motor system. The autonomous transfer vehicle may be a drone. Products from multiple autonomous transfer vehicles may be aggregated at the hyperlocal aggregation facility for delivery by a single delivery vehicle. An efficient delivery route may be determined for multiple aggregated products. Other embodiments are described and claimed.

### CROSS-REFERENCE TO RELATED APPLICATIONS

The present application claims priority under 35 U.S.C. § 119(e) to U.S. Provisional Application Ser. No. 63/119,394, filed Nov. 30, 2020, the entire disclosure of which is hereby incorporated by reference.

### BACKGROUND

The emergence of the COVID-19 pandemic has substantially increased the use of delivery services for fresh food, grocery, and other products. In typical systems for delivery of fresh food and other products, a driver in a vehicle receives a message for pick up of a product. The driver drives to a retail location, parks the vehicle, enters the location, waits to pick up the product, and then drives that product to a designated home for delivery.

### SUMMARY

According to one aspect of the disclosure, a system for intelligent transfer of products includes an autonomous transfer vehicle to (i) receive a retail product associated with an order, wherein the order is further associated with a destination, (ii) navigate to a predetermined location in response to loading of the autonomous transfer vehicle, and (iii) unload the retail product from the autonomous transfer vehicle in response to navigation to the predetermined location. In an embodiment, the system further includes a second autonomous transfer vehicle to (i) receive a second retail product associated with a second order, (ii) navigate to the predetermined location in response to loading of the second autonomous transfer vehicle, and (iii) unload the second retail product from the second autonomous transfer vehicle in response to navigation to the predetermined location.

In an embodiment, the system further includes an order server to receive an order for grocery products, wherein the order is indicative of the retail product and the destination; and determine a delivery vehicle for the order; wherein to navigate to the predetermined location comprises to navigate to a predetermined location associated with the delivery vehicle.

In an embodiment, the autonomous transfer vehicle is further to secure the retail product in response to the loading the autonomous transfer vehicle; authenticate a user in response to the navigation to the predetermined location; and unlock the retail product in response to authentication of the user. In an embodiment, to navigate to the predetermined location comprises to recognize a license plate of the delivery vehicle using a camera of the autonomous transfer vehicle. In an embodiment, to navigate to the predetermined location comprises to perform facial recognition for a user.

In an embodiment, to navigate to the predetermined location comprises to navigate to a hyperlocal aggregation facility. In an embodiment, the autonomous transfer vehicle comprises an autonomous aerial vehicle, and wherein to navigate to the hyperlocal aggregation facility comprises to fly to a loading zone at the hyperlocal aggregation facility.

In an embodiment, the autonomous transfer vehicle is further to raise a product container to contact a body of the autonomous transfer vehicle in response to the loading of the product, wherein the product container is coupled to the body by a cable; and wherein to unload the retail product comprises to lower the product container to the loading zone.

In an embodiment, the system further includes a transfer pad at the loading zone of the hyperlocal aggregation facility to unload the retail product from the autonomous transfer vehicle to the transfer pad; transfer the retail product to an interior of the hyperlocal aggregation facility in response to unloading of the retail product; and return the transfer pad to the loading zone in response to transferring the retail product.

In an embodiment, the system further includes an order server to aggregate the retail product with a second retail product in response to transfer of the retail product to the interior of the hyperlocal aggregation facility, wherein the second retail product is associated with a second order, and wherein the second order is further associated with a second destination; and transfer the retail product and the second retail product to a delivery vehicle in response to aggregation of the retail product with the second retail product.

In an embodiment, the order server is further to determine a delivery route for the retail product and the second retail product, wherein the delivery route is indicative of the destination associated with the retail product and the second destination associated with the second retail product; and provide the delivery route to the delivery vehicle. In an embodiment, to determine the delivery route comprises to determine the delivery route with a machine learning algorithm. In an embodiment, to determine the delivery route with the machine learning algorithm comprises to determine the delivery route with the machine learning algorithm based on a predetermined distance between destinations, a historical efficiency metric, a product type, or a product characteristic.

In an embodiment, the autonomous transfer vehicle comprises a ground vehicle, and wherein to unload the retail product comprises to navigate one or more steps. In an embodiment, to navigate to the hyperlocal aggregation facility comprises to maintain a condition of the retail product. In an embodiment, the system further includes a robotic system at the hyperlocal aggregation facility to unload the retail product.

According to another aspect, a method for intelligent transfer of products includes loading an autonomous transfer vehicle with a retail product associated with an order, wherein the order is further associated with a destination; navigating, by the autonomous transfer vehicle, to a predetermined location in response to loading the autonomous transfer vehicle; and unloading the retail product from the autonomous transfer vehicle in response to navigating to the predetermined location. In an embodiment, the method further includes loading a second autonomous transfer vehicle with a second retail product associated with a second order; navigating, by the second autonomous transfer vehicle, to the predetermined location in response to loading the second autonomous transfer vehicle; and unloading the second retail product from the second autonomous transfer vehicle in response to navigating to the predetermined location.

In an embodiment, the method further includes receiving, by an order server, an order for grocery products, wherein the order is indicative of the retail product and the destination; and determining, by the order server, a delivery vehicle for the order; wherein navigating to the predetermined location comprises navigating to a predetermined location associated with the delivery vehicle.

In an embodiment, the method further includes securing the retail product in response to loading the autonomous transfer vehicle; authenticating, by the autonomous transfer vehicle, a user in response to navigating to the predetermined location; and unlocking, by the autonomous transfer vehicle, the retail product in response to authenticating the user. In an embodiment, navigating to the predetermined location comprises recognizing a license plate of the delivery vehicle using a camera of the autonomous transfer vehicle. In an embodiment, navigating to the predetermined location comprises performing facial recognition for a user.

In an embodiment, navigating to the predetermined location comprises navigating to a hyperlocal aggregation facility. In an embodiment, the autonomous transfer vehicle comprises an autonomous aerial vehicle, and wherein navigating to the hyperlocal aggregation facility comprises flying to a loading zone at the hyperlocal aggregation facility.

In an embodiment, loading the autonomous transfer vehicle comprises raising, by the autonomous transfer vehicle; a product container to contact a body of the autonomous transfer vehicle, wherein the product container is coupled to the body by a cable; and unloading the retail product comprises lowering the product container to the loading zone.

In an embodiment, the method further includes unloading the retail product from the autonomous transfer vehicle to a transfer pad at the loading zone of the hyperlocal aggregation facility; transferring, by the transfer pad, the retail product to an interior of the hyperlocal aggregation facility in response to unloading the retail product; and returning, by the transfer pad, to the loading zone in response to transferring the retail product.

In an embodiment, the method further includes aggregating the retail product with a second retail product in response to transferring the retail product to the interior of the hyperlocal aggregation facility, wherein the second retail product is associated with a second order, and wherein the second order is further associated with a second destination; and transferring the retail product and the second retail product to a delivery vehicle in response to aggregating the retail product with the second retail product.

In an embodiment, the method further includes determining, by an order server, a delivery route for the retail product and the second retail product, wherein the delivery route is indicative of the destination associated with the retail product and the second destination associated with the second retail product; and providing, by the order server, the delivery route to the delivery vehicle. In an embodiment, determining the delivery route comprises determining the delivery route using a machine learning algorithm. In an embodiment, determining the delivery route using the machine learning algorithm comprises determining the delivery route using the machine learning algorithm based on a predetermined distance between destinations, a historical efficiency metric, a product type, or a product characteristic.

In an embodiment, the autonomous transfer vehicle comprises a ground vehicle, and wherein unloading the retail product comprises navigating, by the autonomous transfer vehicle, one or more steps. In an embodiment, navigating to the hyperlocal aggregation facility comprises maintaining, by the autonomous transfer vehicle, a condition of the retail product. In an embodiment, unloading the retail product comprises unloading the retail product by a robotic system at the hyperlocal aggregation facility.

According to another aspect, one or more non-transitory, computer-readable storage media comprising a plurality of instructions that, when executed, cause one or more computing devices to load an autonomous transfer vehicle with a retail product associated with an order, wherein the order is further associated with a destination; navigate, by the autonomous transfer vehicle, to a predetermined location in response to loading the autonomous transfer vehicle; and unload the retail product from the autonomous transfer vehicle in response to navigating to the predetermined location. In an embodiment, the one or more non-transitory, computer-readable storage media further comprises a plurality of instructions that, when executed, cause one or more computing devices to load a second autonomous transfer vehicle with a second retail product associated with a second order; navigate, by the second autonomous transfer vehicle, to the predetermined location in response to loading the second autonomous transfer vehicle; and unload the second retail product from the second autonomous transfer vehicle in response to navigating to the predetermined location.

In an embodiment, the one or more non-transitory, computer-readable storage media further include a plurality of instructions that, when executed, cause one or more computing devices to receive, by an order server, an order for grocery products, wherein the order is indicative of the retail product and the destination; and determine, by the order server, a delivery vehicle for the order; wherein to navigate to the predetermined location comprises to navigate to a predetermined location associated with the delivery vehicle.

In an embodiment, the one or more non-transitory, computer-readable storage media further include a plurality of instructions that, when executed, cause one or more computing devices to secure the retail product in response to loading the autonomous transfer vehicle; authenticate, by the autonomous transfer vehicle, a user in response to navigating to the predetermined location; and unlock, by the autonomous transfer vehicle, the retail product in response to authenticating the user. In an embodiment, to navigate to the predetermined location comprises to recognize a license plate of the delivery vehicle using a camera of the autonomous transfer vehicle. In an embodiment, to navigate to the predetermined location comprises to perform facial recognition for a user.

In an embodiment, to navigate to the predetermined location comprises to navigate to a hyperlocal aggregation facility. In an embodiment, the autonomous transfer vehicle comprises an autonomous aerial vehicle, and wherein to navigate to the hyperlocal aggregation facility comprises to fly to a loading zone at the hyperlocal aggregation facility.

In an embodiment, to load the autonomous transfer vehicle comprises to raise, by the autonomous transfer vehicle; a product container to contact a body of the autonomous transfer vehicle, wherein the product container is coupled to the body by a cable; and to unload the retail product comprises to lower the product container to the loading zone.

In an embodiment, the one or more non-transitory, computer-readable storage media further include a plurality of instructions that, when executed, cause one or more computing devices to unload the retail product from the autonomous transfer vehicle to a transfer pad at the loading zone of the hyperlocal aggregation facility; transfer, by the transfer pad, the retail product to an interior of the hyperlocal aggregation facility in response to unloading the retail product; and return, by the transfer pad, to the loading zone in response to transferring the retail product.

In an embodiment, the one or more non-transitory, computer-readable storage media further include a plurality of instructions that, when executed, cause one or more computing devices to aggregate the retail product with a second retail product in response to transferring the retail product to the interior of the hyperlocal aggregation facility, wherein the second retail product is associated with a second order, and wherein the second order is further associated with a second destination; and transfer the retail product and the second retail product to a delivery vehicle in response to aggregating the retail product with the second retail product.

In an embodiment, the one or more non-transitory, computer-readable storage media further include a plurality of instructions that, when executed, cause one or more computing devices to determine, by an order server, a delivery route for the retail product and the second retail product, wherein the delivery route is indicative of the destination associated with the retail product and the second destination associated with the second retail product; and provide, by the order server, the delivery route to the delivery vehicle. In an embodiment, to determine the delivery route comprises to determine the delivery route using a machine learning algorithm. In an embodiment, to determine the delivery route using the machine learning algorithm comprises to determine the delivery route using the machine learning algorithm based on a predetermined distance between destinations, a historical efficiency metric, a product type, or a product characteristic.

In an embodiment, the autonomous transfer vehicle comprises a ground vehicle, and wherein to unload the retail product comprises to navigate, by the autonomous transfer vehicle, one or more steps. In an embodiment, to navigate to the hyperlocal aggregation facility comprises to maintain, by the autonomous transfer vehicle, a condition of the retail product. In an embodiment, to unload the retail product comprises to unload the retail product by a robotic system at the hyperlocal aggregation facility.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for intelligent transfer of products in a trade area;

FIG. 2 is a simplified block diagram of at least one embodiment of an autonomous transfer vehicle (ATV) of the system of FIG. 1;

FIG. 3 is a schematic diagram of an illustrative trade area for use with the system of FIGS. 1 and 2;

FIG. 4 is a simplified flow diagram of at least one embodiment of a method for intelligently transferring grocery products from a retail store to a delivery vehicle that may be executed by the system of FIGS. 1 and 2;

FIG. 5 is a schematic diagram illustrating at least one potential embodiment of an ATV that may be used with the method of FIG. 4;

FIG. 6 is a schematic diagram illustrating operation of the method of FIG. 4;

FIG. 7 is a simplified flow diagram of at least one embodiment of a method for intelligently transferring products to a hyperlocal aggregation facility that may be executed by the system of FIGS. 1-2;

FIGS. 8 and 9 are schematic diagrams illustrating at least one potential embodiment of an ATV that may be used with the method of FIG. 7;

FIG. 10 is a schematic diagram illustrating unloading products from an ATV at a hyperlocal aggregation facility that may occur in operation of the method of FIG. 7;

FIG. 11 is a simplified flow diagram of at least one embodiment of a method for sorting and bundling products for delivery that may be executed by the system of FIGS. 1-2; and

FIG. 12 is a simplified flow diagram of at least one embodiment of a method for generating efficient routes for delivery of multiple products that may be executed by the system of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

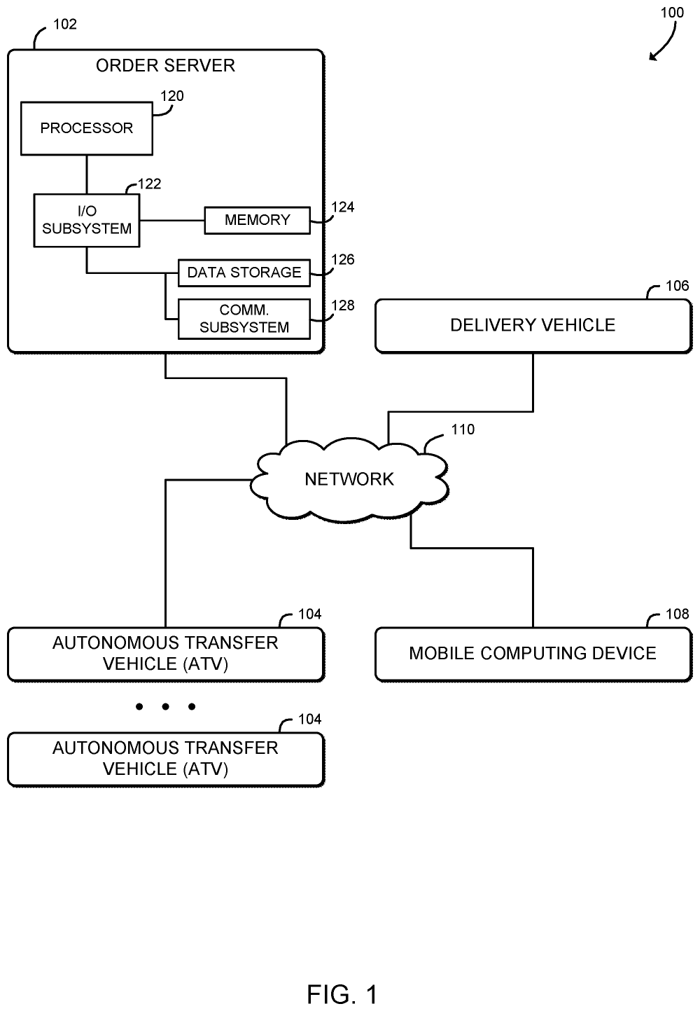

Referring now to FIG. 1, an illustrative system 100 for intelligent transfer of products in a trade area includes an order server 102, which may be in communication with multiple autonomous transfer vehicles (ATVs) 104, delivery vehicles 106, and/or mobile computing devices 108 over a network 110. In use, as described further below, products may be loaded into one or more ATVs 104 for transfer to delivery vehicles 106 and/or to a hyperlocal aggregation facility. Software platforms which may be executed by the order server 102 may group and aggregate products so that products from multiple sources and/or to multiple destinations may be grouped and loaded into delivery vehicles 106 to be dropped off on predetermined routes. Thus, the system 100 allows for businesses to efficiently transfer products in an automated way to vehicles or to a hyperlocal aggregation facility. The system 100 further allows products to be combined in an intelligent way and loaded into vehicles and then for those vehicles to drop off the aggregated products on the most efficient, planned routes. Accordingly, the system 100 may improve efficiency as compared to existing delivery systems by avoiding waiting time for drivers or delivery vehicles, by combining multiple orders and/or products into a single delivery vehicle, and by improving route efficiency. Accordingly, the system 100 may reduce costs of delivery and/or increase availability of delivery for many products.

As described further below, the order server 102 is configured to provide order processing services, product aggregation services, route determination services, and other software platform services to a hyperlocal aggregation facility and other components of the system 100. Accordingly, the order server 102 may be embodied as any type of device capable of performing the functions described herein. For example, the order server 102 may be embodied as, without limitation, a server, a rack-mounted server, a blade server, a workstation, a network appliance, a web appliance, a desktop computer, a laptop computer, a tablet computer, a smartphone, a consumer electronic device, a distributed computing system, a multiprocessor system, and/or any other computing device capable of performing the functions described herein. Additionally, in some embodiments, the order server 102 may be embodied as a “virtual server” formed from multiple computing devices distributed across the network 110 and operating in a public or private cloud. Accordingly, although the order server 102 is illustrated in FIG. 1 as embodied as a single computing device, it should be appreciated that the order server 102 may be embodied as multiple devices cooperating together to facilitate the functionality described below. As shown in FIG. 1, the illustrative order server 102 includes a processor 120, an I/O subsystem 122, memory 124, a data storage device 126, and a communication subsystem 128. Of course, the order server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the order server 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the order server 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the order server 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the order server 102 may be embodied as any communication circuit, device, or collection thereof, capable of enabling communications between the order server 102, the ATV 104, the delivery vehicle 106, and/or other remote devices. The communication subsystem 128 may be configured to use any one or more communication technology (e.g., wireless or wired communications) and associated protocols (e.g., Ethernet, Bluetooth®, Bluetooth Low Energy (BLE), Wi-Fi®, WiMAX, 3G LTE, 5G, etc.) to effect such communication.

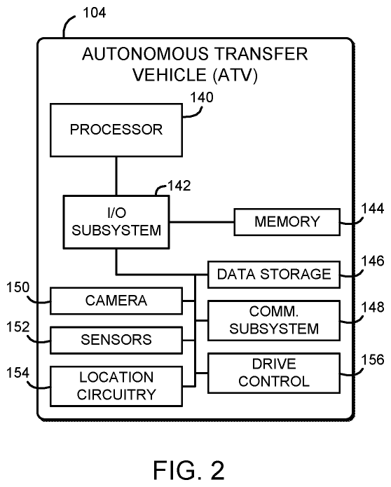

Each ATV 104 may be embodied as an autonomous ground vehicle, autonomous aerial vehicle, drone, multirotor aircraft, or other vehicle capable of autonomously navigating in the environment. Each ATV 104 also includes one or more cargo compartments or other storage locations for products being transferred by the ATV 104. As shown in FIG. 2, each ATV 104 includes components and devices commonly found in a computer or similar computing device, such as a processor 140, an I/O subsystem 142, a memory 144, a data storage device 146, and/or communication circuitry 148. Those individual components of the ATV 104 may be similar to the corresponding components of the order server 102, the description of which is applicable to the corresponding components of the ATV 104 and is not repeated herein so as not to obscure the present disclosure.

As shown, the ATV 104 further includes a camera 150, one or more sensors 152, location circuitry 154, and a drive control subsystem 156. The camera 150 may be embodied as a digital camera or other digital imaging device integrated with the ATV 104 or otherwise communicatively coupled thereto. The camera 150 includes an electronic image sensor, such as an active-pixel sensor (APS), e.g., a complementary metal-oxide-semiconductor (CMOS) sensor, or a charge-coupled device (CCD). The camera 150 may be used to capture image data including, in some embodiments, capturing still images or video images.

Each of the sensors 152 may be embodied as an accelerometer, gyroscope, magnetic compass, depth sensor, lidar sensor, structured light sensor, thermometer, thermocouple, or other sensor capable of generating sensor data indicative of the environment of the ATV 104. The ATV 104 may use one or more of the sensors 152 for navigation or for other purposes, such as for monitoring the condition of one or more products being transferred by the ATV 104.

The location circuitry 154 may be embodied as any type of circuit capable of determining the precise or approximate position of the ATV 104. For example, the location circuitry 154 may be embodied as a global positioning system (GPS) receiver, capable of determining the precise coordinates of the ATV 104. In other embodiments, the location circuitry 154 may triangulate or trilaterate the position of the ATV 104 using distances or angles to cellular network towers or other radio beacons with known positions, which may be provided by the communication subsystem 148. In other embodiments, the location circuitry 154 may determine the approximate position of the ATV 104 based on association to wireless networks with known positions, using the communication subsystem 148. In some embodiments, the location circuitry 154 may be capable of determining the location of the ATV 104 using a local positioning system such as a system of beacons or other positioning devices installed in an indoor or outdoor location.

The drive control subsystem 156 may include any control system capable of autonomously controlling movement of the ATV 104. In some embodiments, the drive control subsystem 156 may be embodied as a full autonomous driving subsystem. In such embodiments, the drive control subsystem 156 may be capable of controlling the movement of the ATV 104 from a starting position to a destination position. In those embodiments, the drive control subsystem 156 may fully control acceleration, steering, braking, collision avoidance, and other driving tasks of the ATV 104. Additionally or alternatively, in some embodiments the drive control subsystem 156 may be embodied as an autonomous flight control subsystem. In such embodiments, the drive control subsystem 156 may fully control rotor speed, altitude, attitude (e.g., pitch, roll, and yaw), ground speed, and other flying tasks of the ATV 104.

As shown in FIG. 1, the system 100 further includes one or more delivery vehicles 106 and/or mobile computing devices 108. Each delivery vehicle 106 may be embodied as a car, a truck, a vehicle computer, an in-vehicle infotainment device, an embedded controller, an ECU, or another type of vehicle or vehicle computer. Each delivery vehicle 106 may be autonomous, semi-autonomous, or manually operated. Each mobile computing device 108 may be embodied as a smartphone, a computer, a tablet computer, a laptop computer, a notebook computer, a wearable computing device, a multiprocessor system, a network appliance, a web appliance, a distributed computing system, a processor-based system, and/or a consumer electronic device. In some embodiments, each mobile computer device 108 may be coupled to or otherwise associated with a delivery vehicle 106 and/or with a driver of the corresponding delivery vehicle 106. Accordingly, each of the delivery vehicle 106 and the mobile computing device 108 includes components and devices commonly found in a computer or similar computing device, such as a processor, an I/O subsystem, a memory, a data storage device, and/or communication circuitry. Those individual components of the delivery vehicle 106 and/or the mobile computing device 108 may be similar to the corresponding components of the order server 102, the description of which is applicable to the corresponding components of the delivery vehicle 106 and the mobile computing device 108 and is not repeated herein so as not to obscure the present disclosure.

As discussed in more detail below, the order server 102, the ATVs 104, the delivery vehicles 106, and the mobile computing device 108 may be configured to transmit and receive data with each other and/or other devices of the system 100 over the network 110. The network 110 may be embodied as any number of various wired and/or wireless networks. For example, the network 110 may be embodied as, or otherwise include, a wired or wireless local area network (LAN), a wired or wireless wide area network (WAN), a cellular network, and/or a publicly-accessible, global network such as the Internet. As such, the network 110 may include any number of additional devices, such as additional computers, routers, stations, and switches, to facilitate communications among the devices of the system 100.

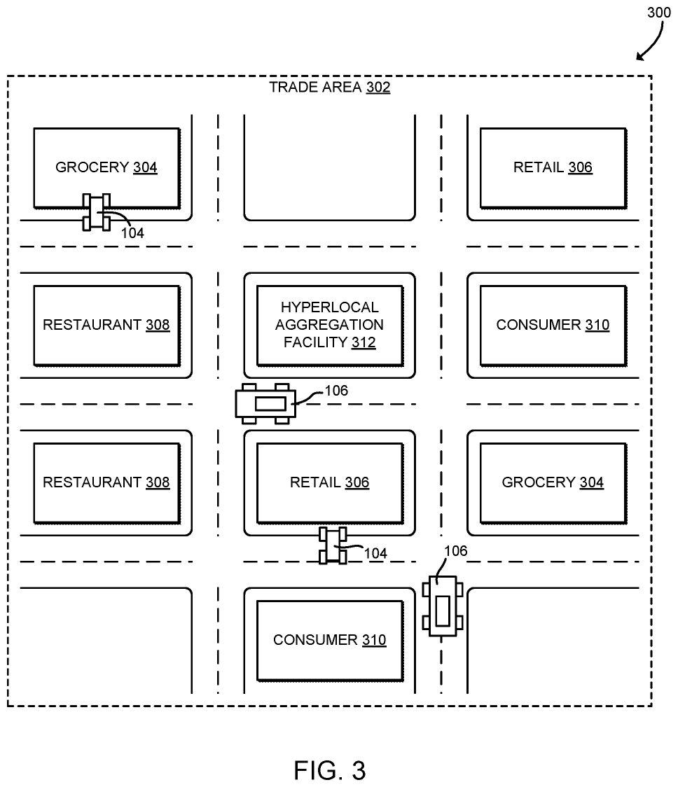

Referring now to FIG. 3, diagram 300 illustrates one potential embodiment of a trade area 302 that may be serviced by the system 100. The trade area 302 may be embodied as an urban or suburban neighborhood or other region that includes multiple retail outlets or other businesses, aggregation facilities, and consumer homes or other destinations, as well as a road network or other local transportation system. Illustratively, the trade area 302 includes multiple grocery stores 304, which may be embodied as grocery stores, convenience stores, or other retail outlets that sell fresh food or other grocery products; retail stores 306, which may be embodied as big box stores, electronic stores, clothing stores, or other retail stores; restaurants 308, which may be embodied as quick service restaurants, fast food restaurants, full service restaurants, or other restaurants; and consumer locations 310, which may be embodied as homes, offices, or other destinations for retail products. The trade area 302 also includes a hyperlocal aggregation facility 312, which may be embodied as a virtual kitchen center, a ghost kitchen, a food hall, or other facility that may perform the functions described herein. In some embodiments, the hyperlocal aggregation facility 312 may host or otherwise access order processing services, product aggregation services, route determination services, and other software platform services provided by the order server 102. As described further below, one or more ATVs 104 may transfer fresh food, grocery products, or other retail products from one or more grocery stores 304, retail stores 306, restaurants 308, or other businesses to a delivery vehicle 106 for delivery to a consumer 310. Additionally or alternatively, in some embodiments one or more ATVs 104 may transfer fresh food, grocery products, or other retail products from one or more grocery stores 304, retail stores 306, restaurants 308, or other businesses to the hyperlocal aggregation facility 312. Products may be sorted and combined at the hyperlocal aggregation facility 312 for delivery by one or more delivery vehicles 106 to one or more consumers 310.

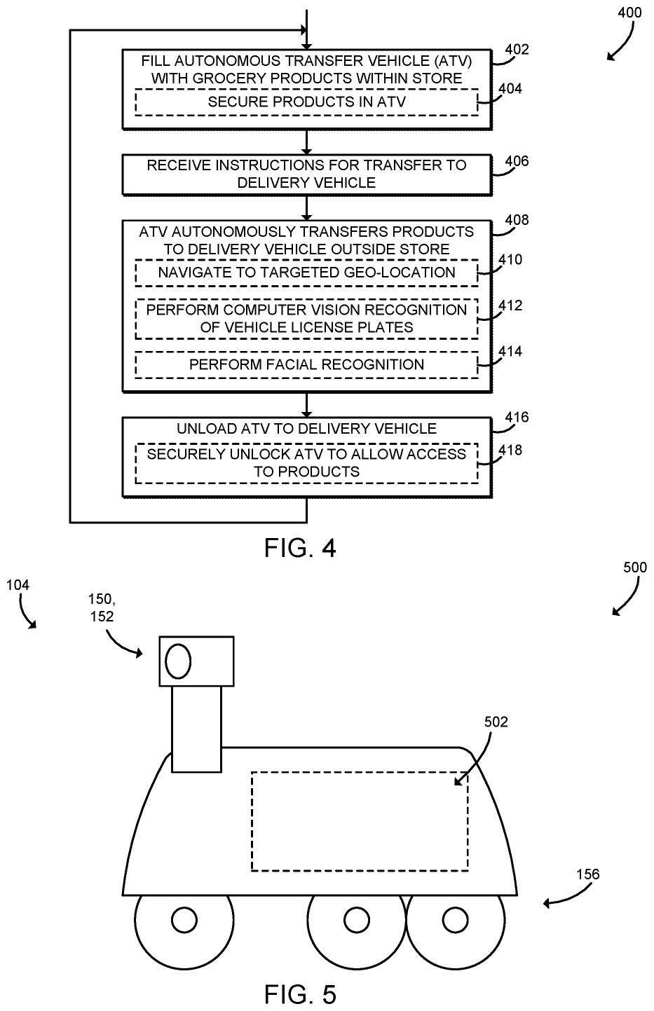

Referring now to FIG. 4, in use, the system 100 may execute a method 400 for intelligently transferring grocery products from a retail store to a delivery vehicle 106. The method 400 begins with block 402, in which an ATV 104 is filled with grocery products within a grocery store 304 or other business. The grocery products may correspond to an order placed by a consumer with the order server 102. Thus, the order may also be associated with an address or other location of the consumer 310. Additionally, the order server 102 may associate the order with a particular delivery vehicle 106. In some embodiments, in block 404 the grocery products may be secured in the ATV 104. For example, the ATV 104 may lock a compartment or otherwise restrict access to the grocery products after receiving the grocery products.

In block 406, the ATV 104 receives instructions for transferring the grocery products to the delivery vehicle 106. The instructions may identify a predetermined location associated with the delivery vehicle 106 (e.g., a predetermined parking space located near the grocery store 304). In some embodiments, the instructions may identify the delivery vehicle 106 itself, for example by license plate number or description.

In block 408, the ATV 104 autonomously transfers the grocery products to the delivery vehicle 106 positioned outside of the grocery store 304. The ATV 104 may autonomously navigate from the interior of the grocery store 304 to an exterior location such as a parking lot nearby the delivery vehicle 106. The ATV 104 may use any appropriate technique to navigate to the delivery vehicle 106. In some embodiments, in block 410 the ATV 104 may navigate to a targeted geo-location, such as a predetermined location, a current position of the delivery vehicle 106, or other geo-location. In some embodiments, in block 412 the ATV 104 may perform computer vision recognition of vehicle license plates in order to identify and/or confirm the identity of the delivery vehicle 106. In some embodiments, in block 414 the ATV 104 may perform facial recognition of a driver or other user associated with the delivery vehicle 106.

In block 416, the grocery products transferred by the ATV 104 are unloaded to the delivery vehicle 104. The ATV 104 may open a compartment or otherwise provide access to the grocery products. In some embodiments, in block 418 the ATV 104 may securely unlock the compartment in order to allow access to the grocery products. For example, the ATV 104 may authenticate the driver or other user of the delivery vehicle 106 before unlocking the cargo compartment. The ATV 104 may use any technique to authenticate the user, such as a QR code or other code, facial recognition, palm recognition, voice recognition, or other techniques. In some embodiments, the ATV 104 may read a QR code from or otherwise communicate with a mobile computing device 108 in order to authenticate the associated user. After unloading the ATV 104, the method 400 loops back to block 402, in which additional ATVs 104 may transfer products from a retail store. In some embodiments, multiple ATVs 104 from different retail stores and/or hyperlocal aggregation facilities may navigate to the same delivery vehicle 106 for delivery. For example, an ATV 104 transferring groceries from a grocery store 304 and another ATV 104 transferring fresh food from a virtual kitchen center 312 may navigate to the location of a single delivery vehicle 106. That delivery vehicle 106 may deliver those products to one or more consumers 310 as part of a planned route, as described further below.

Potential embodiments of ATVs 104 for use with the method 400 may include low-speed, non-highway autonomous delivery vehicles. For example, in one embodiment, the ATV 104 may be embodied as or similar to a motorized shopping cart that includes a vision system, an electric motor system, and/or other autonomous driving features. As another example, and referring now to FIG. 5, one potential embodiment of an ATV 104 that may be used with the method 400 is shown. The illustrative ATV 104 shown in FIG. 5 is a robotic delivery vehicle 500 that includes a lockable internal payload compartment 502. The vehicle 500 further includes a camera vision system 150, multiple sensors 152, and a wheeled drive subsystem 156.

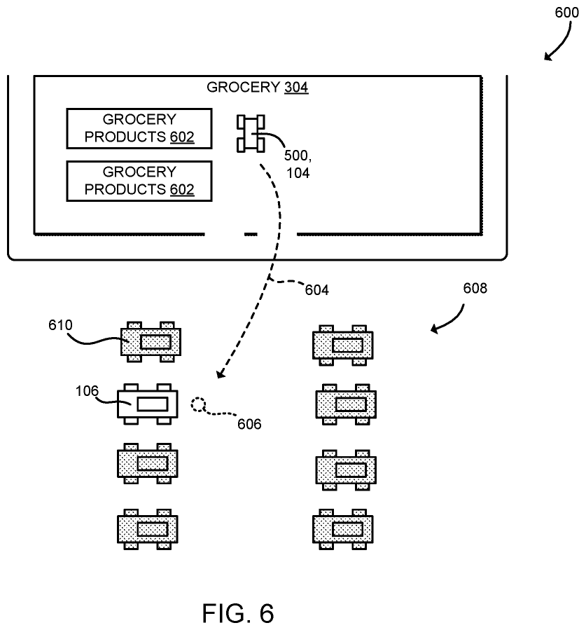

Referring now to FIG. 6, diagram 600 illustrates one potential embodiment of operation of the method 400. As shown, an autonomous grocery cart 104 may be filled with grocery products 602 inside a grocery store 304. The grocery cart 104 then autonomously transfers 604 the grocery products 602 to a defined location 606 in a parking lot 608 outside of the grocery store 304. As described above, software systems (for example, one or more applications or other systems executed by the order server 102) may be used to deliver multiple autonomous grocery carts 104 to the location 606 of a single delivery vehicle 106 so that the delivery vehicle 106 can deliver multiple packages on a planned route. As another example, the system 100 organizes the movement of a shopping cart 104 comprised of groceries and the movement of another shopping cart 104 comprised of fresh food from a virtual kitchen center (e.g. a hyperlocal aggregation facility 312) to a single delivery vehicle 106 in the parking lot 608 of the grocery store 304. As described above, there are various mechanisms that may be used for the grocery cart 104 to autonomously move to the defined location 606 in the parking lot 608, including (but not limited to) computer vision of license plates (for example, to identify the delivery vehicle 106 and/or other vehicles 610), facial recognition, and targeted geo-locations. As described above, the shopping cart 104 may include mechanisms for securely transporting products, such as a system for locking the packages inside of the grocery cart 104. The driver of the delivery vehicle 106 may be able to unlock the cart 104 using various mechanisms, including (but not limited to) QR codes, facial recognition, palm recognition, or voice recognition.

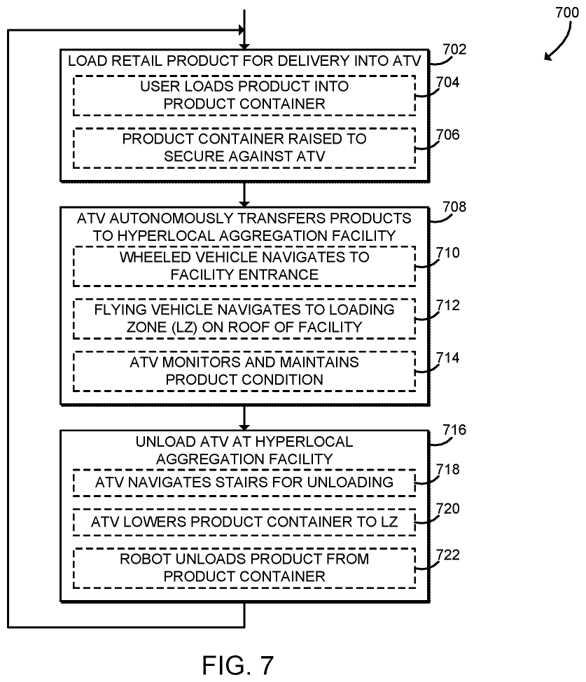

Referring now to FIG. 7, in use, the system 100 may execute a method 700 for intelligently transferring products to a hyperlocal aggregation facility 312. The method 700 begins with block 702, in which an ATV 104 is filled with one or more retail products for delivery to a consumer 310. The products may be retail products from a grocery or convenience store 304, a retail store 306, a restaurant 308, or other business in the trade area 302. As described above, the ATV 104 may be embodied as a ground vehicle such as an autonomous shopping cart or a robotic delivery vehicle, as a flying vehicle such as a drone or multirotor aircraft, or as another type of autonomous vehicle. In some embodiments, in block 704 a user may load the product into a product container of the ATV 104. For example, a user may load product into an ATV 104 that is positioned on a sidewalk near the business or otherwise positioned nearby. As another example, a user may load product into a product container that is lowered from a flying ATV 104 while the ATV 104 is hovering. In those embodiments, the product container may be formed from a soft material to prevent potential injures to the user or other persons nearby. After loading the product, the ATV 104 may lock or otherwise secure the product container as described above. In some embodiments, in block 706 the product container may be raised to secure the product container against the body of the ATV 104 in preparation for flight.

In block 708, the ATV 104 autonomously navigates with the loaded product to a hyperlocal aggregation facility 312. In some embodiments, in block 710 a ground ATV 104 may navigate to an entrance of the hyperlocal aggregation facility 312. The ATV 104 may, for example, navigate on sidewalks, across streets, or otherwise arrive at an entrance of the hyperlocal aggregation facility 312. In some embodiments, in block 712 a flying ATV 104 may navigate to a loading zone (LZ) positioned on a rooftop of the hyperlocal aggregation facility 312 or otherwise positioned near the hyperlocal aggregation facility 312. In some embodiments, in block 714 the ATV 104 may monitor and/or maintain the condition of the product during navigation. For example, the ATV 104 may use one or more thermometers or other sensors 152 to monitor temperature of fresh food stored in the product container, and in some embodiments may use active heating and/or cooling to maintain that temperature.

In block 716, after arriving at the hyperlocal aggregation facility 312, the product is unloaded from the ATV 104. The product container may be securely unlocked to allow access to the product as described further above. The product may be unloaded by one or more users at the hyperlocal aggregation facility 312, and may be bundled with other products for delivery as described further below. In some embodiments, in block 718 the ATV 104 may navigate one or more stairs to perform unloading. For example, the ATV 104 may traverse one or more curbs, steps, and/or stairs in order to enter the hyperlocal aggregation facility 312 and unload the product. In some embodiments, in block 720 the ATV 104 may lower the product container to the LZ located on the roof of the hyperlocal aggregation facility. Once on the roof, a user may unload the product from the product container. In some embodiments, in block 722 a robotic arm or other robotic system located at the hyperlocal aggregation facility 312 may unload the product from the product container. After unloading the product, the method 700 loops back to block 702 in order to transfer additional products to the hyperlocal aggregation facility 312. Thus, multiple ATVs 104 may transfer products from different businesses to the same hyperlocal aggregation facility 312 for delivery.

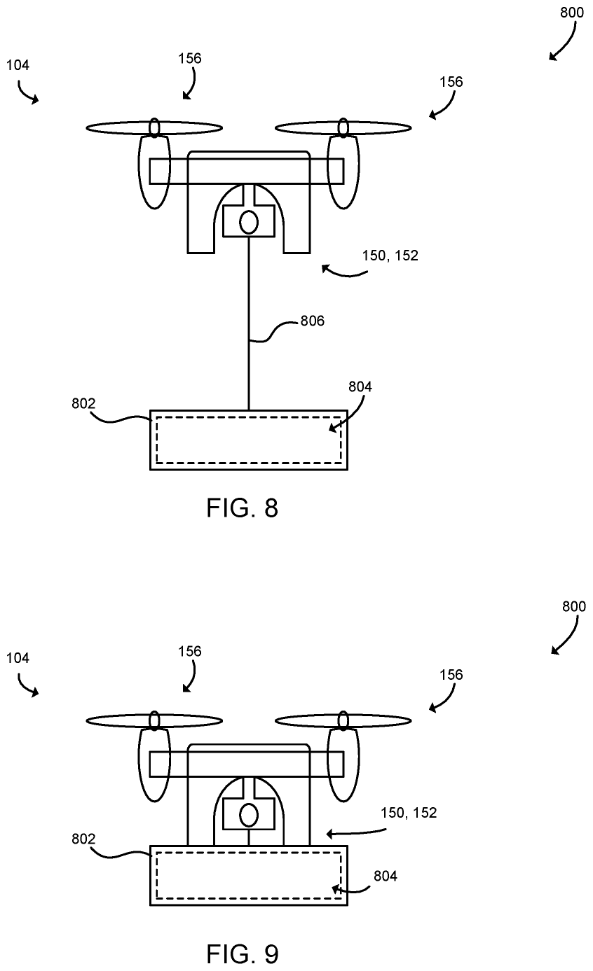

Referring now to FIGS. 8-9, one potential embodiment of a flying ATV 104 that may be used with the method 700 is shown. The illustrative ATV 104 is a multirotor aircraft or drone 800 that includes a product container 802 that includes an internal payload compartment 804. The product container 802 is coupled to the drone 800 by a cable 806, and may be lowered away from the drone 800 as shown in FIG. 8 or raised to securely contact the drone 800 as shown in FIG. 9. The illustrative drone 800 further includes a camera vision system 150, multiple sensors 152, and an electric rotor drive subsystem 156.

In an illustrative example, the product container 802 is capable of holding products such as food, wine, and other retail goods. Continuing that example, the drone 800 may hover over a designated area of a parking lot and lower the connection cable 806 attached to the product container 802. A person may deposit a product in the product container 802, and the drone 800 may raise the connection cable 806 connected to the product container 802 so that the product container 802 firmly attaches to the drone 800. The drone 800 can then fly with the product to a hyperlocal aggregation facility 312 and deposit the product on the roof of the hyperlocal aggregation facility 312.

The product container 802 may have a range of different dimensions depending on the payloads being carried. For example, a product container 802 used to transport consumer electronics from a retail store 306 may be different from a product container 802 used to transport pizza from a restaurant 308. The product container 802 may also include sensors, heaters, and coolers to monitor the payload and maintain the payload in a particular condition (e.g., at a particular temperature).

As described above, in an embodiment, the product container 802 connected to the drone 800 by the connection cable 806 is made of a soft material. In case the product container 802 comes into contact with a person when it is being lowered, it will not result in injury.

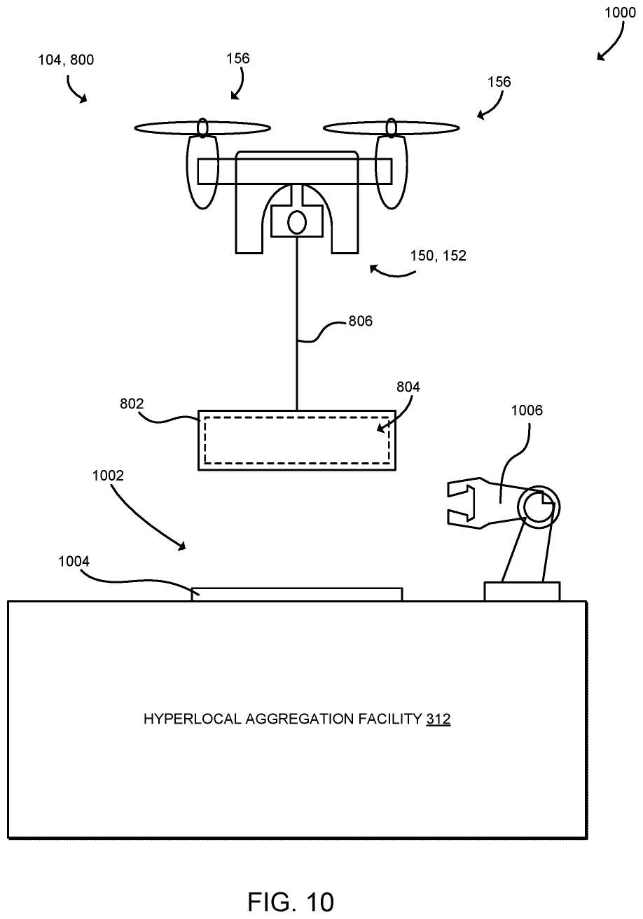

Referring now to FIG. 10, diagram 1000 illustrates one potential embodiment of delivery of a product by the drone 800 to the hyperlocal aggregation facility 312. As shown, the ATV 104 may hover over the hyperlocal aggregation facility 312 and lower the product container 802 containing the product(s) down to a designated area 1002 (e.g., the LZ 1002) on the roof of the hyperlocal aggregation facility 312. As described further below, in some embodiments the product may be unloaded onto a moveable transfer pad 1004 located at the designated area 1002 of the roof In a specific embodiment, a worker on the roof may open the product container 802, remove the product from the product container 802, and the product container 802 can be brought back to the autonomous machine 104 through the connection cable 806. Alternatively, a robot 1006 may autonomously remove the product from the product container 802, and the product container 802 can be brought back (i.e., raised) to the autonomous machine 104 through the connection cable 806.

Additionally or alternatively, instead of the autonomous machine 104 lowering the product container 802 through the connection cable 806, in another embodiment, the autonomous machine 104 may land at the designated area 1002 on the roof of the hyperlocal aggregation facility 312. A worker or a robot 1006 can then remove the product from the product container 802, and the autonomous machine 104 can then take off to pick up another good at a specific location.

In some embodiments, the roof of the hyperlocal aggregation facility 312 may include charging boxes or other charging equipment so that the autonomous machines 104 can charge when they are not transferring products. Additionally or alternatively, in some embodiments, the roof of the hyperlocal aggregation facility 312 may include a hanger, a garage, or other secure storage facility for the autonomous machines 104 to be stored when not in use (e.g., at night).

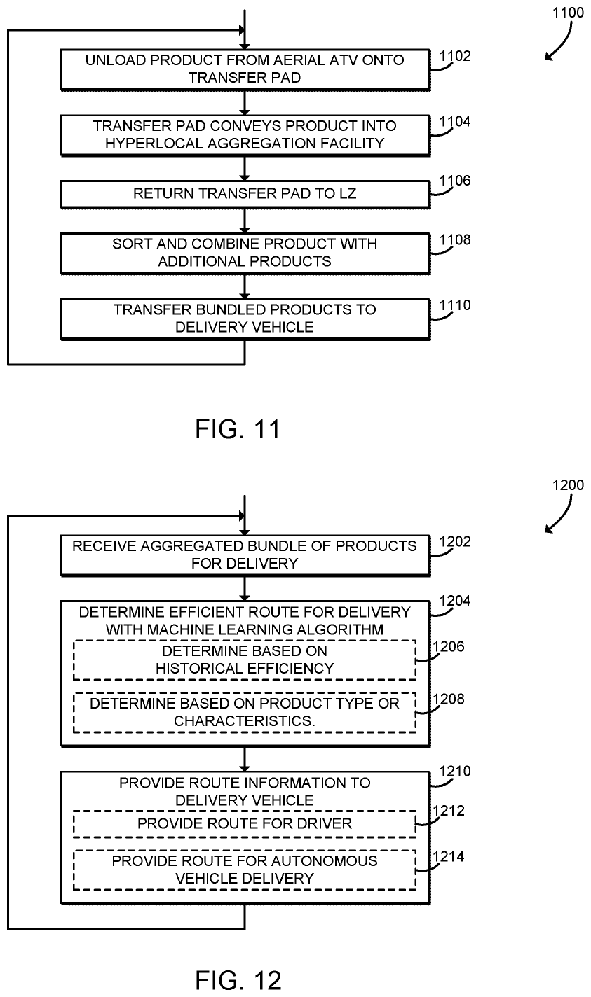

Referring now to FIG. 11, in use, the system 100 may execute a method 1100 for sorting and bundling products for delivery at a hyperlocal aggregation facility 312. The method 1100 may be executed, for example, after transferring a product to a hyperlocal aggregation facility 312 as described above in connection with the method 700 of FIG. 7. The method 1100 begins with block 1102, in which product is unloaded from an aerial ATV 104 onto a transfer pad 1004 located at the loading zone (LZ) 1002 of the hyperlocal aggregation facility 312. As an illustrative example, an apparatus at the hyperlocal aggregation facility 312 receives an incoming package from an air-born machine 104 and transfers the package in an automated way from the roof of the hyperlocal aggregation facility 312 into the facility 312 to be combined in an intelligent way with other packages and loaded into delivery vehicles 106.

In block 1104, the transfer pad conveys the product into the hyperlocal aggregation facility 312. As described above, the transfer pad 1004 may be a portable pad capable of conveying the product into the hyperlocal aggregation facility 312. In block 1106, the transfer pad returns to the LZ 1002. This allows the transfer pad to receive additional products from other ATVs 104. Thus, the apparatus of the hyperlocal aggregation facility 312 further comprises a mechanism for the transfer of products to be continuous so that the portable pad 1004 can be returned to the roof for another package to be deposited.

In block 1108, the received product is sorted and combined with one or more additional products for delivery. The product may be intelligently grouped by the order server 102 or another software platform of the hyperlocal aggregation facility 312. The combined products may be grouped in a bundle, which may be a logical or physical grouping of products. For example, products may be combined in an intelligent way and then loaded into delivery vehicles 106. Continuing that example, in the case of grocery products, machine learning techniques may be used to determine that orders from three different households 310 within a certain proximity to each other should all be combined into one delivery vehicle 106. As another example, in the case of a hyperlocal aggregation facility 312, machine learning techniques may be used to determine that orders from two local restaurants 308 and a convenience store 304 should all be combined and loaded into one delivery vehicle 106 at the hyperlocal aggregation facility 312.

In block 1110, the bundled products are transferred to a delivery vehicle 106. As described further below, a route may be provided to the delivery vehicle 106 for delivery of the bundled products. After transferring the bundled products to the delivery vehicle 106, the method 1100 loops back to block 1102 to continue sorting and bundling products received from ATVs 104.

Referring now to FIG. 12, in use, the system 100 may execute a method 1200 for generating efficient routes for delivery of multiple products. The method 1200 may be executed, for example, in connection with bundling multiple products for delivery as described above in connection with the method 1100 of FIG. 11. The method 1200 begins with block 1202, in which an aggregated bundle of products are received for delivery at a hyperlocal aggregation facility 312. The products may be bundled, for example, as described above in connection with the method 1100.

In block 1204, the hyperlocal aggregation facility 312 and/or the associated order server 102 determines an efficient route for delivery of the bundled products using a machine learning algorithm. The route may include locations for multiple consumers 310 to receive bundled products, and may identify an efficient order of delivery or other delivery characteristics. Thus, software platforms (such as the order server 102) may learn over time what are the most efficient routes for different kinds of products to be dropped off at multiple locations on the route. In some embodiments, in block 1206 the route may be determined based on historical efficiency. In some embodiments, in block 1208 the route may be determined based on product type and/or product characteristics. For example, if an order from one household 310 is for a box of candy and an order from another household 310 is for a fresh cheeseburger, the software system (e.g., the order server 102) might prioritize delivery of the fresh cheeseburger and plan a route accordingly for the driver of the delivery vehicle 106.

In block 1210, the hyperlocal aggregation facility 312 and/or an associated order server 102 provides route information to a delivery vehicle 106 for delivery of the bundled products. In some embodiments, in block 1212 the route may be provided for the driver of the delivery vehicle 106. For example, the route may be provided to a mobile computing device 108 or other navigation device usable by the driver. In some embodiments, in block 1214 route may be provided for autonomous delivery by the delivery vehicle 106. After providing the route information, the method 1200 loops back to block 1202, in which additional products may be routed for delivery.

1. A system for intelligent transfer of products, the system comprising:
an autonomous transfer vehicle to (i) receive a retail product associated with an order, wherein the order is further associated with a destination, (ii) navigate to a predetermined location in response to loading of the autonomous transfer vehicle, and (iii) unload the retail product from the autonomous transfer vehicle in response to navigation to the predetermined location.

2. The system of claim 1, further comprising:
a second autonomous transfer vehicle to (i) receive a second retail product associated with a second order, (ii) navigate to the predetermined location in response to loading of the second autonomous transfer vehicle, and (iii) unload the second retail product from the second autonomous transfer vehicle in response to navigation to the predetermined location.

3. The system of claim 1, further comprising an order server to:
receive an order for grocery products, wherein the order is indicative of the retail product and the destination; and
determine a delivery vehicle for the order;
wherein to navigate to the predetermined location comprises to navigate to a predetermined location associated with the delivery vehicle.

4. The system of claim 3, wherein the autonomous transfer vehicle is further to:
secure the retail product in response to the loading the autonomous transfer vehicle;
authenticate a user in response to the navigation to the predetermined location; and
unlock the retail product in response to authentication of the user.

5. The system of claim 3, wherein to navigate to the predetermined location comprises to recognize a license plate of the delivery vehicle using a camera of the autonomous transfer vehicle or to perform facial recognition for a user.

6. The system of claim 1, wherein to navigate to the predetermined location comprises to navigate to a hyperlocal aggregation facility.

7. The system of claim 6, wherein the autonomous transfer vehicle comprises an autonomous aerial vehicle, and wherein to navigate to the hyperlocal aggregation facility comprises to fly to a loading zone at the hyperlocal aggregation facility, wherein the autonomous transfer vehicle is further to:
raise a product container to contact a body of the autonomous transfer vehicle in response to the loading of the product, wherein the product container is coupled to the body by a cable; and
wherein to unload the retail product comprises to lower the product container to the loading zone.

8. The system of claim 7, further comprising:
a transfer pad at the loading zone of the hyperlocal aggregation facility to:
unload the retail product from the autonomous transfer vehicle to the transfer pad;
transfer the retail product to an interior of the hyperlocal aggregation facility in response to unloading of the retail product; and
return the transfer pad to the loading zone in response to transferring the retail product; and
an order server to:
aggregate the retail product with a second retail product in response to transfer of the retail product to the interior of the hyperlocal aggregation facility, wherein the second retail product is associated with a second order, and wherein the second order is further associated with a second destination; and
transfer the retail product and the second retail product to a delivery vehicle in response to aggregation of the retail product with the second retail product.

9. The system of claim 8, wherein the order server is further to:
determine a delivery route for the retail product and the second retail product, wherein the delivery route is indicative of the destination associated with the retail product and the second destination associated with the second retail product; and
provide the delivery route to the delivery vehicle.

10. The system of claim 9, wherein to determine the delivery route comprises to determine the delivery route with a machine learning algorithm.

11. The system of claim 6, wherein to navigate to the hyperlocal aggregation facility comprises to maintain a condition of the retail product.

12. The system of claim 6, further comprising a robotic system at the hyperlocal aggregation facility to unload the retail product.

13. A method for intelligent transfer of products, the method comprising:
loading an autonomous transfer vehicle with a retail product associated with an order, wherein the order is further associated with a destination;
navigating, by the autonomous transfer vehicle, to a predetermined location in response to loading the autonomous transfer vehicle; and
unloading the retail product from the autonomous transfer vehicle in response to navigating to the predetermined location.

14. The method of claim 13, further comprising:
loading a second autonomous transfer vehicle with a second retail product associated with a second order;
navigating, by the second autonomous transfer vehicle, to the predetermined location in response to loading the second autonomous transfer vehicle; and
unloading the second retail product from the second autonomous transfer vehicle in response to navigating to the predetermined location.

15. The method of claim 13, further comprising:
receiving, by an order server, an order for grocery products, wherein the order is indicative of the retail product and the destination; and
determining, by the order server, a delivery vehicle for the order; and
wherein navigating to the predetermined location comprises navigating to a predetermined location associated with the delivery vehicle.

16. The method of claim 13, wherein navigating to the predetermined location comprises navigating to a hyperlocal aggregation facility.

17. One or more non-transitory, computer-readable storage media comprising a plurality of instructions that, when executed, cause one or more computing devices to:
load an autonomous transfer vehicle with a retail product associated with an order, wherein the order is further associated with a destination;
navigate, by the autonomous transfer vehicle, to a predetermined location in response to loading the autonomous transfer vehicle; and
unload the retail product from the autonomous transfer vehicle in response to navigating to the predetermined location.

18. The one or more non-transitory, computer-readable storage media of claim 17, further comprising a plurality of instructions that, when executed, cause one or more computing devices to:
load a second autonomous transfer vehicle with a second retail product associated with a second order;
navigate, by the second autonomous transfer vehicle, to the predetermined location in response to loading the second autonomous transfer vehicle; and
unload the second retail product from the second autonomous transfer vehicle in response to navigating to the predetermined location.

19. The one or more non-transitory, computer-readable storage media of claim 17, further comprising a plurality of instructions that, when executed, cause one or more computing devices to:
receive, by an order server, an order for grocery products, wherein the order is indicative of the retail product and the destination; and
determine, by the order server, a delivery vehicle for the order;
wherein to navigate to the predetermined location comprises to navigate to a predetermined location associated with the delivery vehicle.

20. The one or more non-transitory, computer-readable storage media of claim 17, wherein to navigate to the predetermined location comprises to navigate to a hyperlocal aggregation facility.
